(19) United States
(12) Patent Application Publication
(10) Pub. No.: US 2010/0279205 A1
(43) Pub. Date: Nov. 4, 2010

(54) FUEL CARTRIDGE, FUEL CELL, AND ELECTRONIC DEVICE

(75) Inventors: Yuto Takagi, Kanagawa (JP); Yoshiaki Inoue, Aichi (JP); Atsushi Sato, Kanagawa (JP); Kazuaki Fukushima, Kanagawa (JP); Jusuke Shimura, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/809,826

(22) PCT Filed: Dec. 17, 2008
(86) PCT No.: PCT/JP2008/072961

§ 371 Date: Jun. 21, 2010

(30) Foreign Application Priority Data
Dec. 28, 2007 (JP) P2007-339156

(51) Int. Cl. H01M 2/08

(52) U.S. Cl. 429/507

(57) ABSTRACT

A fuel cartridge with which damage or break of a valve due to miss-loading or the like is able to be avoided and safety is able to be improved, a fuel cell, and an electronic device are provided. A fitting groove for fitting to a fuel cell body is provided in a package of a fuel cartridge. Improper force applied to a valve due to inappropriate loading or the like is avoided, and possibility that the valve is damaged or broken is decreased. The valve is provided not projecting from the package. Compared to an existing structure that a valve is projecting outside of the package, the effective volume of a fuel storage space is increased even if the height of the entire cartridge is the same as that of the existing case.

### CROSS REFERENCE TO RELATED APPLICATIONS

The present application is a National Stage of International Application No. PCT/JP2008/072961 filed on Dec. 17, 2008 and which claims priority to Japanese Patent Application No. 2007-339156 filed on Dec. 28, 2007, the entire contents of which are being incorporated herein by reference.

### BACKGROUND

The present disclosure relates to a fuel cartridge for storing a fuel cell-use fuel, a fuel cell including the same, and an electronic device including the fuel cell.

A fuel cell has a structure in which an electrolyte is arranged between an anode electrode (fuel electrode) and a cathode electrode (oxygen electrode). A fuel is supplied to the anode electrode, and an oxidant is supplied to the cathode electrode. At this time, redox reaction in which the fuel is oxidized by the oxidant is initiated, and chemical energy contained in the fuel is converted to electric energy.

Such a fuel cell is able to continuously generate power by continuously supplying the fuel and the oxidant. Thus, the fuel cell is expected as a new power source for a mobile electronic device different from the existing primary battery or the existing secondary battery. That is, since the fuel cell generates power by using chemical reaction between the fuel and the oxidant, if oxygen in the air is used as the oxidant and the fuel is continuously resupplied from outside, the fuel cell is able to be continuously used as a power source unless the fuel cell goes out of order. Thus, a downsized fuel cell is able to become a high energy density power source that is suitable for a mobile electronic device without necessity of charging.

To refuel the fuel cell, an exchangeable fuel cartridge in which a valve for refueling is attached to a package containing the fuel is desirably used. As the fuel contained in the fuel cartridge, different types of fuels containing various components may be used in addition to methanol. Further, fuels having the same component may have each different concentration. Thus, if the fuel cartridge applied to the fuel cell is misused, a fuel with different component and different concentration is supplied to the fuel cell. In the result, there is a possibility that a problem such as incapability of obtaining inherent performance of the fuel cell and accelerated deterioration of the fuel cell is generated.

In the past, for example, as described in Patent Document 1, a cylindrical body has been provided around the valve, and the shape of the cylindrical body has varied according to the fuel type. Further, in Patent Document 2, the valve itself has a geometric key shape for connecting the valve to a fuel supply port linked with the fuel cell.

Patent Document 1: Japanese Unexamined Patent Application Publication No. 2006-54055

Patent Document 2: Japanese Translation of PCT International Application Publication No. 2006-523937

However, the strength of the valve or the surroundings thereof is small. Thus, if such regions have a key function, improper force is applied to the valve at the time of inappropriate loading or the like, and thereby the valve may be damaged or broken. Further, to give the key function to the valve or the surroundings thereof, the valve should have a shape projecting from the package. Thus, the size of the package should be decreased by just that much, and the volumetric efficiency of the fuel deteriorates.

In view of the foregoing problems, it is desired to provide a fuel cartridge with which damage or break of the valve due to miss-loading or the like is able to be avoided and safety is able to be improved, a fuel cell, and an electronic device.

### SUMMARY

A fuel cartridge according to an embodiment includes a package containing a fuel for a fuel cell body. The package has a fitting groove for fitting to the fuel cell body.

A fuel cell according to an embodiment includes a fuel cell body generating power by being supplied with a fuel and oxidant gas and a fuel cartridge. The fuel cartridge is composed of the foregoing fuel cartridge of the present invention.

An electronic device according to the present embodiment includes the foregoing fuel cell.

In the fuel cartridge, the fuel cell, and the electronic device of the embodiments, the fitting groove for fitting to the fuel cell body is provided in the package of the fuel cartridge. Thus, improper force applied to the valve due to inappropriate loading or the like is able to be avoided, and possibility that the valve is damaged or broken is decreased. Accordingly, safety is improved.

According to the fuel cartridge, the fuel cell, and the electronic device of the embodiments, the fitting groove for fitting to the fuel cell body is provided in the package of the fuel cartridge. Thus, damage or break of the valve due to miss-loading or the like is able to be avoided, and safety is able to be improved.

Additional features and advantages are described herein, and will be apparent from, the following Detailed Description and the figures.

### BRIEF DESCRIPTION OF THE FIGURES

FIG. 1 is a perspective view and a cross sectional view illustrating an appearance of a fuel cartridge according to an embodiment o and the internal structure thereof.

FIG. 2 is a perspective view illustrating a structure of a fuel cell body onto which the fuel cartridge illustrated in FIG. 1 is loaded.

FIG. 3 is a perspective view illustrating a method of loading the fuel cartridge illustrated in FIG. 1 onto the fuel cell body.

FIG. 4 is an exploded perspective view illustrating a structural example of a power generation section contained in the fuel cell body illustrated in FIG. 2.

FIG. 5 is a cross sectional view illustrating a structure of the power generation section illustrated in FIG. 4.

FIG. 6 is a plan view illustrating the structure of the power generation section illustrated in FIG. 4.

FIG. 7 is a cross sectional view for explaining a method of manufacturing the power generation section illustrated in FIG. 4.

FIG. 8 is a cross sectional view for explaining the method of manufacturing the power generation section illustrated in FIG. 4.

FIG. 9 is a perspective view illustrating an appearance of a fuel cartridge according to a first modified example.

FIG. 10 is a perspective view and a cross sectional view illustrating an appearance of a fuel cartridge according to a second modified example and the internal structure thereof.

FIG. 11 is a perspective view illustrating an application example.

### DETAILED DESCRIPTION

An embodiment will be hereinafter described in detail.

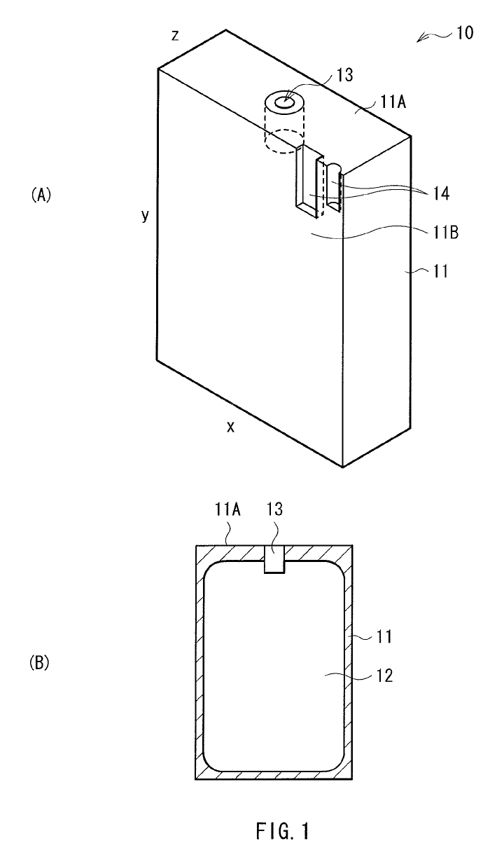

FIG. 1 illustrates an appearance of a fuel cartridge according to an embodiment and the internal structure thereof. A fuel cartridge 10 is a changeable fuel cartridge used for a fuel cell loaded as a power source for a mobile electronic device such as a mobile phone and a notebook PC (Personal Computer). For example, the fuel cartridge 10 has a fuel storage space 12 containing methanol or the like as a fuel inside a package 11. A valve 13 for delivering the fuel from the fuel storage space 12 is provided in a top face 11A of the package 11.

The package 11 has the shape of a flat rectangular solid, that is, the shape of a rectangular solid in which four sides z in the thickness direction out of four sides x in the width direction, four sides y in the height direction, and the four sides z in the thickness direction are shortest. The package 11 has, for example, a thickness about from 5 mm to 10 mm both inclusive, and is made of a metal material such as aluminum and stainless steel, or a resin material such as PET (polyethylene terephthalate) and polypropylene.

The valve 13 is preferably provided in the shape not projecting from the package 11. That is, it is preferable that the valve 13 is buried in the package 11, and an end thereof is located in the upper face 11A. In this case, compared to an existing structure that a valve projects outside of the package, the effective volume of the fuel storage space 12 is able to be increased even if the height of the entire fuel cartridge 10 is the same as that of the existing case. Further, in a fuel cell body 20 described later, a space for receiving the projecting valve is not necessitated.

The package 11 is provided with a fitting groove 14 for fitting to the fuel cell body 20. Thereby, in the fuel cartridge 10, damage or break of the valve 13 due to miss-loading or the like is able to be avoided and safety is able to be improved.

In the fitting groove 14, for example, one end is located in the same plane as that of the end of the valve 13, that is, in the top face 11A of the package 11. The fitting groove 14 is provided in parallel with the longitudinal direction of the valve 13 from the one end to a side face 11B of the package 11. Thereby, the structure of the fuel cartridge 10 is able to be simplified, and the structure of the fuel cell body 20 on which the fuel cartridge 10 is loaded is able to be simplified.

The end of the fitting groove 14 is preferably provided in a position different from the position of the end of the valve 13 in the top face 11A of the package 11. Thereby, the thickness of the package 11 is able to be further decreased. For example, in the case where the end of the valve 13 is provided in the center of the top face 11A of the package 11, the end of the fitting groove 14 is provided in a position not in the vicinity of the center of the top face 11A but in the vicinity of an end of the top face 11A.

The number of the fitting grooves 14 is not particularly limited. For example, in the case where one fitting groove 14 is provided, type or concentration of the fuel is able to be determined by the position and the shape (for example, width, length, and cross sectional shape) or the like of the fitting groove 14. For example, it is possible that a plurality of fitting grooves 14 are provided, fuel type is determined by one fitting groove 14, and fuel concentration is determined by another fitting groove 14. In all cases, it is able to avoid accidently supply a different type of fuel or a fuel with a different concentration.

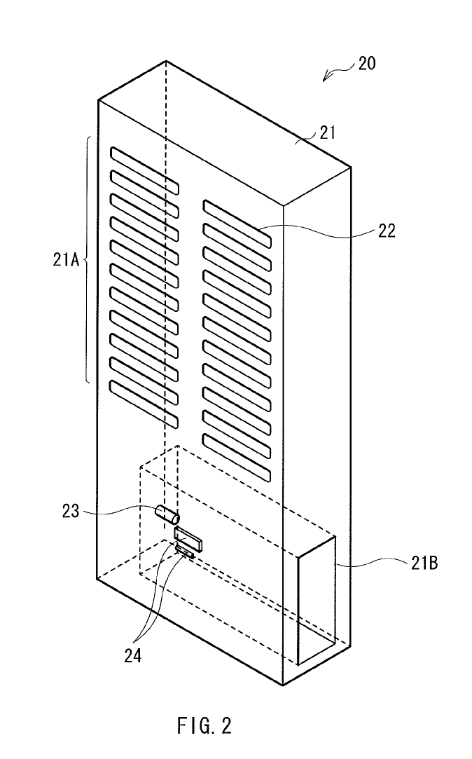

FIG. 2 illustrates an appearance of the fuel cell body 20 onto which the fuel cartridge 10 is loaded. The fuel cell body 20 has, for example, a package member 21 having a thickness about from 10 mm to 20 mm both inclusive, and is made of a metal material such as stainless steel and aluminum, or a resin material such as PET and polypropylene. The package member 21 is provided with a power generation section container 21A that contains an after-mentioned power generation section and a fuel cartridge loading section 21B for loading the fuel cartridge 10. The power generation section container 21A is provided with a through hole 22 for passing air (oxygen) as an oxidant.

The fuel cartridge loading section 21B is, for example, a concave section provided in the package member 21. The fuel cartridge 10 is loaded by being inserted into the fuel cartridge loading section 21B keeping the top face 11A of the package 11 forefront.

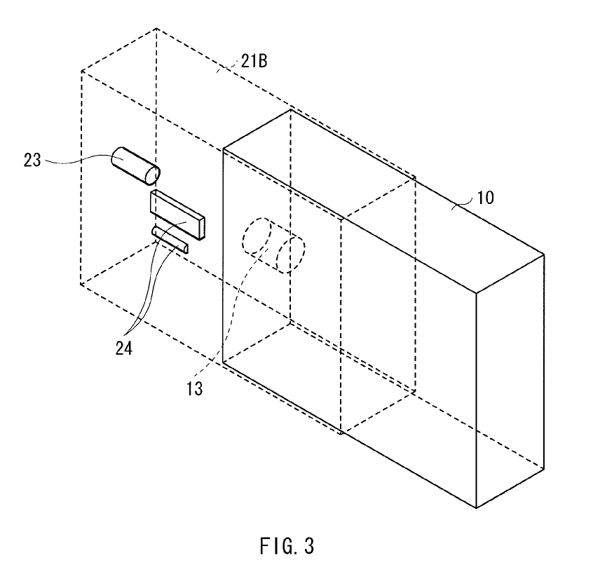

The fuel cartridge loading section 21B is provided with a valve connection pipe 23 corresponding to the valve 13 of the fuel cartridge 10 and a fitting projection 24 corresponding to the fitting groove 14. The valve connection pipe 23 is inserted into the valve 13 to open the valve 13. The length thereof is, for example, equal to the length of the valve 13. The fitting projection 24 is fitted to the fitting groove 14, and thereby miss-loading is able to be avoided. The length of the fitting projection 24 is preferably longer than the length of the valve connection pipe 23. As illustrated in FIG. 3, in the case where an inappropriate fuel cartridge 10 not having the fitting groove 14 corresponding to the fitting projection 24 is accidentally inserted, before the valve connection pipe 23 is contacted with the valve 13, the fitting projection 24 is contacted with the fuel cartridge 10 and prevents an inappropriate fuel cartridge 10 from being further inserted.

The foregoing description is summarized as follows. A length L13 of the valve 13, a length L14 of the fitting groove 14, a length L23 of the valve connection pipe 23, and a length L24 of the fitting projection 24 preferably satisfy Mathematical formula 1.

(Mathematical formula 1)

L13=L23

L23<L24

L24≦L14

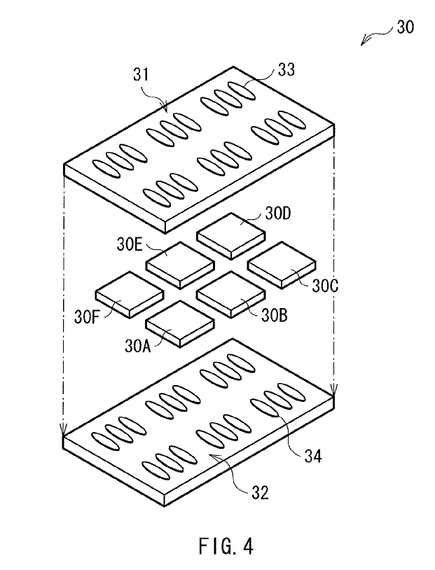

FIG. 4 illustrates a schematic structure of a power generation section 30 contained in the power generation section container 21A. The power generation section 30 is a Direct Methanol Fuel Cell for performing power generation by reaction between methanol and oxygen. The power generation section 30 has a structure in which one or a plurality of unit cells 30A to 30F (for example, 6 pieces in FIG. 4) having a cathode (oxygen electrode) and an anode (fuel electrode) are sandwiched between a cathode plate 31 and an anode plate 32.

The cathode plate 31 and the anode plate 32 have a function as a fixing member for respectively fixing positions of the cathode and the anode of the power generation section 30. The cathode plate 31 and the anode plate 32 respectively have a thickness of, for example, about from 0.5 mm to 1.0 mm both inclusive, and are made of stainless steel, aluminum or the like. The cathode plate 31 is provided with a through hole 33 for passing air (oxygen) as an oxidant. A fuel diffusion plate (not illustrated) for diffusing and evaporating the fuel is provided below the anode plate 32. Methanol supplied from the valve connection pipe 23 is diffused and evaporated in the fuel diffusion plate, passes through a through hole 34 of the anode plate 32 in vaporized state, and is supplied to the anode of the unit cells 30A to 30F. In addition, methanol may be supplied in a liquid state.

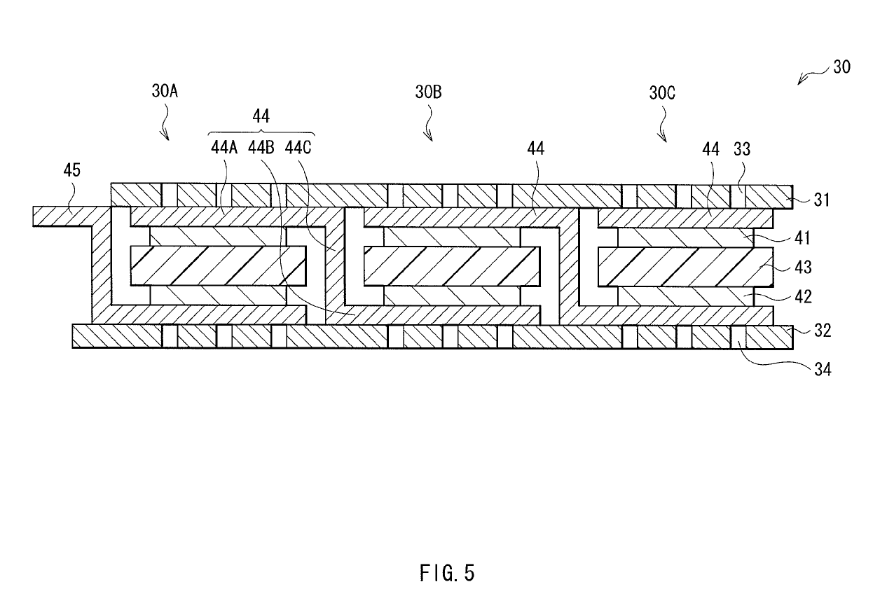

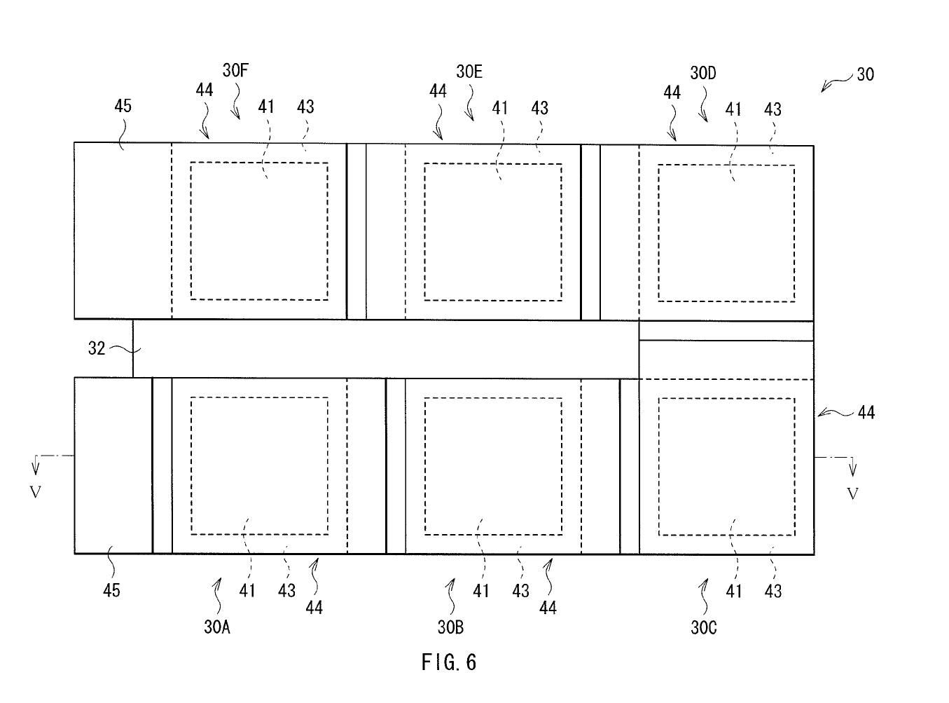

FIG. 5 and FIG. 6 illustrate a structural example of the unit cells 30A to 30F of the power generation section 30. FIG. 5 corresponds to a cross sectional structure taken along line V-V of FIG. 6. The unit cells 30A to 30F respectively have an electrolyte film 43 between a cathode (oxygen electrode) 41 and an anode (fuel electrode) 42. The unit cells 30A to 30F are arranged, for example, in a matrix of three by two in the in-plane direction, and has a planar laminated structure in which each thereof is electrically connected to each other in series by a plurality of connection members 44. The unit cells 30A to 30F are attached with a terminal 45 as an extension portion of the connection members 44.

The cathode 41 and the anode 42 have a structure in which, for example, a catalyst layer containing a catalyst such as platinum (Pt) and ruthenium (Ru) is formed on a current collector made of, for example, a carbon paper or the like. The catalyst layer is made of, for example, a substance in which a supporting body such as carbon black that supports a catalyst is dispersed in a polyperfluoroalkyl sulfonic acid system proton conductive material or the like. In addition, an air supply pump not illustrated may be connected to the cathode 41. Otherwise, it is possible that communication to outside is made through an aperture (not illustrated) provided in the connection member 44, and air, that is, oxygen is supplied by natural ventilation.

The electrolyte film 43 is made of, for example, a proton conductive material having a sulfonate group (—SO₃H). Examples of the proton conductive material include polyperfluoroalkyl sulfonic acid system proton conductive material (for example, “Nafion (registered trademark),” manufactured by Du Pont), a hydrocarbon system proton conductive material such as polyimide sulothic acid, and a fullerene system proton conductive material.

The connection member 44 has a bend section 44C between two flat sections 44A and 44B. The flat section 44A is contacted with the anode 42 of one unit cell (for example, 30A), and the flat section 44B is contacted with the cathode 41 of an adjacent unit cell (for example, 30B), and thereby the adjacent two unit cells (for example, 30A and 30B) are electrically connected in series. Further, the connection member 44 has a function as a current collector to collect electricity generated in the respective unit cells 30A to 30F. Such a connection member 44 has, for example, a thickness of 150 μm, is composed of copper (Cu), nickel (Ni), titanium (Ti), or stainless steel (SUS), and may be plated with gold (Au), platinum (Pt) or the like. Further, the connection member 44 has an aperture (not illustrated) for respectively supplying air and the fuel to the cathode 41 and the anode 42. The connection member 44 is made of, for example, mesh such as an expanded metal, a punching metal or the like. The bend section 44C may be previously bent according to the thickness of the unit cells 30A to 30F. Otherwise, in the case where the connection member 44 is made of a material having flexibility such as mesh having a thickness of 200 μm or less, the bend section 44C may be formed by being bent in a manufacturing process. Such a connection member 44 is jointed with the unit cells 30A to 30F by, for example, screwing a sealing material (not illustrated) such as PPS (polyphenylene sulfide) and silicone rubber provided around the electrolyte film 43 into the connection member 44.

The fuel cell is able to be manufactured, for example, as follows.

First, the fuel cartridge 10 illustrated in FIG. 1 is formed. First, the fitting groove 14 is provided from the top face 11A to the side face 11B in the package 11 made of the foregoing material by, for example, press work. Next, a hole for attaching the valve 13 is provided in the top face 11A of the package 11 by, for example, boring work with the use of a drill or the like. The valve 13 is attached into the hole, and the fuel is injected into the fuel storage space 12. Thereby, the fuel cartridge 10 illustrated in FIG. 1 is formed.

Subsequently, the fuel cell body illustrated in FIG. 2 is formed. First, the electrolyte film 43 made of the foregoing material is sandwiched between the cathode 41 and the anode 42 made of the foregoing material. The resultant is jointed by thermal compression bond. Thereby, the unit cells 30A to 30F are formed.

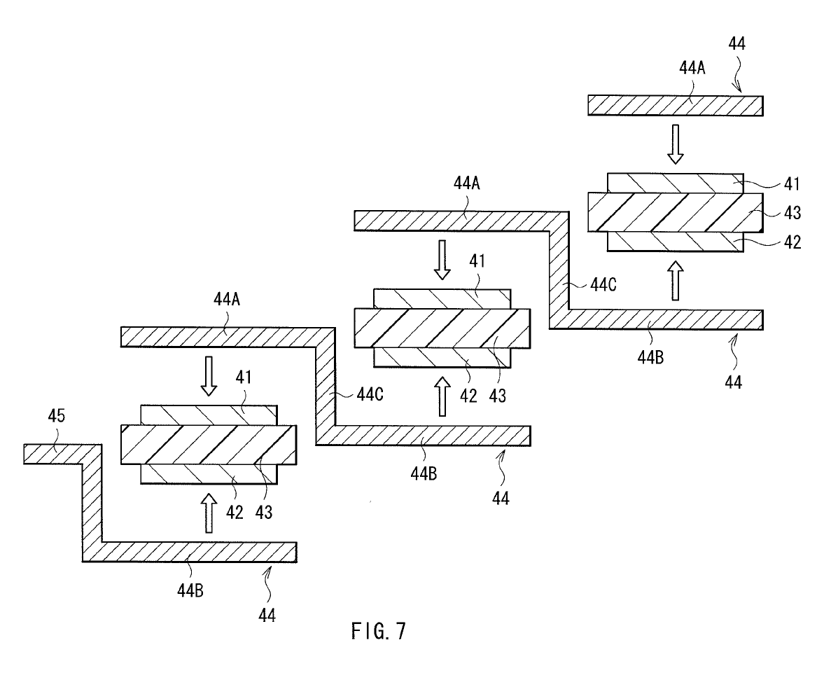

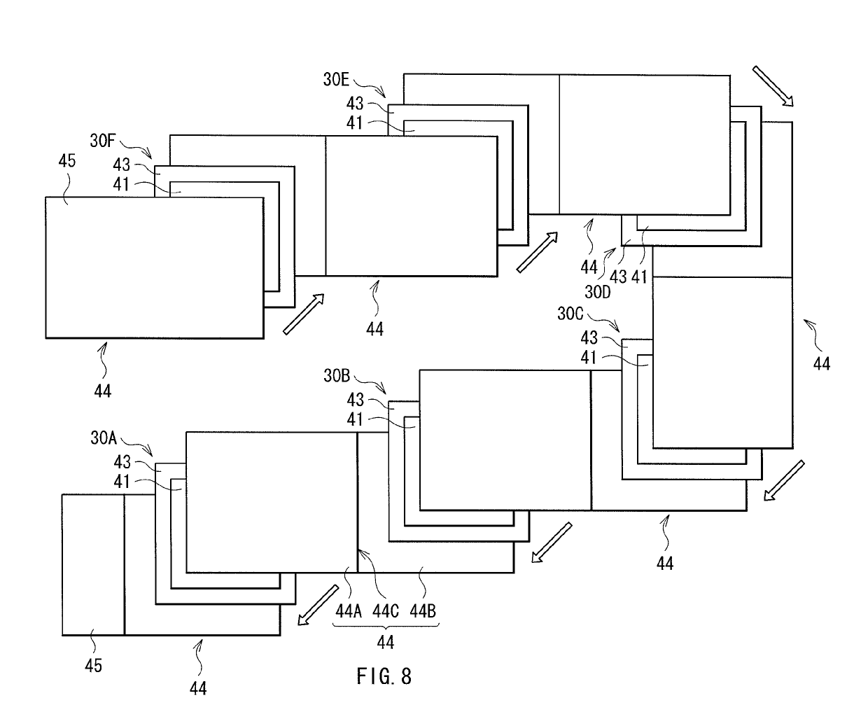

Next, the connection member 44 made of the foregoing material is prepared. As illustrated in FIG. 7 and FIG. 8, the six unit cells 30A to 30F are arranged in a matrix of three by two, and are electrically connected to each other in series by the connection member 44. The sealing material (not illustrated) made of the foregoing material is provided around the electrolyte film 43, and the sealing material is screwed and fixed on the bend section 44C of the connection member 44.

Subsequently, the cathode plate 31 and the anode plate 32 made of the foregoing material are prepared. The cathode plate 31 is arranged on the cathode 41 side of the linked unit cells 30A to 30F, and the anode plate 32 is arranged on the anode 42 side. Accordingly, the power generation section 30 illustrated in FIG. 4 to FIG. 6 is formed.

After that, the package member 21 made of the foregoing material is prepared. The power generation section 30 is contained in the power generation section container 21A of the package member 21. The valve connection pipe 23 is arranged between the power generation section 30 and the fuel cartridge loading section 21B. Accordingly, the fuel cell body 20 illustrated in FIG. 2 is completed.

After the fuel cell body 20 is formed, the fuel cartridge 10 is loaded onto the fuel cartridge loading section 21B of the fuel cell body 20 by inserting the fuel cartridge 10 keeping the top face 11A of the package 11 forefront. At this time, if an appropriate fuel cartridge 10 is inserted in an appropriate direction, the fitting groove 14 of the fuel cartridge 10 is fitted to the fitting projection 24 of the fuel cartridge loading section 21B, and the valve 13 is opened by inserting the valve connection pipe 23 into the valve 13. In this case, since the fitting groove 14 is provided in the package 11 having a relatively large strength, there is a small possibility that the package 11 is damaged or broken by inappropriate loading or the like.

On the other hand, in the past, the valve or the surroundings have been provided with the hard key function. Thus, in the past, there has been a possibility that improper force is applied to the valve at the time of inappropriate loading or the like, and thereby the valve may be damaged or broken, leading to a major safety problem such as fuel leakage.

Further, as illustrated in FIG. 3, in the case where the length of the fitting projection 24 is longer than the length of the valve connection pipe 23, if an inappropriate fuel cartridge 10 not having the fitting groove 14 corresponding to the fitting projection 24 is accidentally inserted, before the valve connection pipe 23 is contacted with the valve 13, the fitting projection 24 is contacted with the fuel cartridge 10. Thus, the inappropriate fuel cartridge 10 is surely prevented from being further inserted, and safety is further improved.

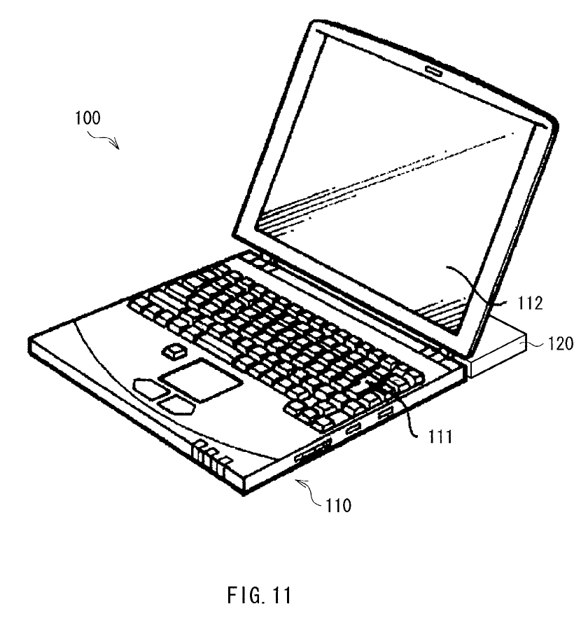

In the fuel cell, the fuel is supplied to the anode 42 of the respective unit cells 30A to 30F, and reaction is initiated to generate protons and electrons. The protons are moved through the electrolyte film 43 to the cathode 41, are reacted with electrons and oxygen to generate water. Thereby, part of chemical energy of the fuel, that is, methanol is converted to electric energy, which is collected by the connection member 44, and is extracted as an output current from the power generation section 30. Electro motive force by the output current and the power generation section 30 is supplied to an external load (not illustrated in FIG. 1 and FIG. 2, and refer to FIG. 11), and the load is driven.

In this case, since the package 11 of the fuel cartridge 10 is provided with the fitting groove 14 engaged with the fuel cell body 20. Thereby, damage or break of the package 11 or the valve 13 due to miss-loading or the like is avoided. Accordingly, safety is improved.

Further, a possibility that a fuel with different component and different concentration is supplied to the power generation section 30 by miss-loading an inappropriate cartridge is decreased. In the result, a fuel with appropriate component and appropriate concentration is supplied to the power generation section 30, an inherent performance of the fuel cell is obtained, and there is no possibility that deterioration of the fuel cell is accelerated.

As described above, in this embodiment, since the package 11 of the fuel cartridge 10 is provided with the fitting groove 14 engaged with the fuel cell body 20. Thus, damage or break of the valve 13 due to miss-loading or the like is able to be avoided, and safety is able to be improved.

In addition, in the foregoing embodiment, the description is given of the case that one end of the fitting groove 14 is located in the same plane as that of the end of the valve 13, that is, in the top face 11A of the package 11, and the fitting groove 14 is provided in parallel with the longitudinal direction of the valve 13 from the one end to the side face 11B of the package 11. However, the position and the shape of the fitting groove 14 vary according to the method of loading the fuel cartridge 10 onto the fuel cell body 20.

That is, in the foregoing embodiment, one stage loading method is used. In such a method, by only inserting the fuel cartridge 10 into the fuel cartridge loading section 21B of the fuel cell body 20, fitting the fitting groove 14 to the fitting projection 24 and connection of the valve 13 to the valve connection pipe 23 are concurrently made. Further, the fitting groove 14 suitable for such a method is provided. However, for example, it is possible to adopt two stage loading method as a method of loading the fuel cartridge 10 onto the fuel cell body 20 of the fuel cartridge 10. In such a method, first, the fitting groove 14 is fitted to the fitting projection 24. After that, the valve 13 is connected to the valve connection pipe 23. In this case, the position and the shape of the fitting groove 14 are not necessarily the position and the shape as described in the foregoing embodiment.

### FIRST MODIFIED EXAMPLE

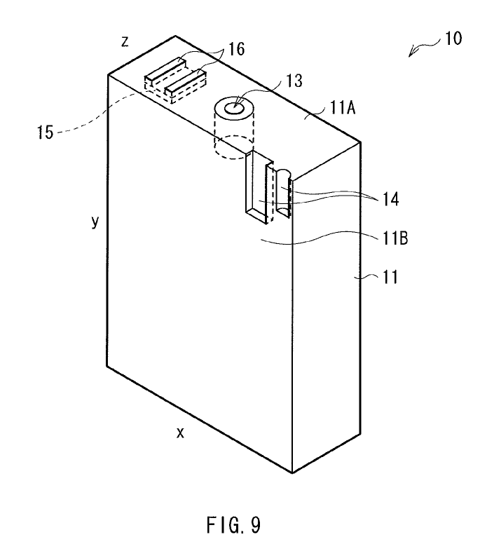

FIG. 9 illustrates a structure of the fuel cartridge 10 according to a first modified example. The fuel cartridge 10 has a structure similar to that of the foregoing embodiment except that a cartridge information storage circuit 15 and a communication terminal 16 are provided in the package 11. The fuel cartridge 10 is able to be manufactured in the same manner as that of the foregoing embodiment, and the fuel cartridge 10 is able to be loaded onto the fuel cell body 20 in the same manner as that of the foregoing embodiment.

The cartridge information storage circuit 15 stores information on a fuel contained in the package 11. The communication terminal 16 is a communication terminal between the cartridge information storage circuit 15 and the fuel cell body 20. By providing the cartridge information storage circuit 15 and the communication terminal 16, fuel type is able to be identified or a remaining amount is able to be controlled, and convenience and safety are able to be further improved.

Further, the cartridge information storage circuit 15 and the communication terminal 16 are provided on the top face 11A of the package 11. Thereby, extra space of the top face 11A of the package 11 is able to be effectively used without decreasing the effective volume of the fuel storage space 12.

### SECOND MODIFIED EXAMPLE

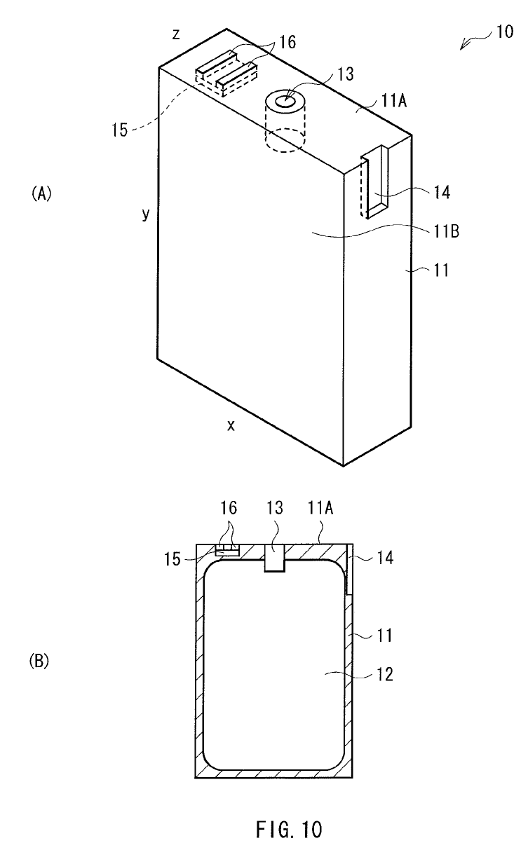

FIG. 10 illustrates a structure of the fuel cartridge 10 according to a second modified example. The fuel cartridge 10 has a structure similar to that of the foregoing first modified example except that the fitting groove 14 is provided at the corner of the package 11, that is, in a side face 11C including the side z in the shortest thickness direction of the package 11. The fuel cartridge 10 is able to be manufactured in the same manner as that of the first modified example, and the fuel cartridge 10 is able to be loaded onto the fuel cell body 20 in the same manner as that of the first modified example.

In the fitting groove 14, for example, one end is located in the same plane as that of the end of the valve 13, that is, in the top face 11A of the package 11. The fitting groove 14 is provided in parallel with the longitudinal direction of the valve 13 from the one end to the side face 11C of the package 11. By providing the fitting groove 14 at the corner of the package 11, the package 11 is able to be further thinned.

### APPLICATION EXAMPLE

FIG. 11 illustrates an appearance of an electronic device including the fuel cell described in the foregoing embodiment. An electronic device 100 is a portable electronic device including a device body 110 and a fuel cell 120 such as a notebook personal computer. The device body 110 is driven by electric energy generated in the fuel cell 120.

The device body 110 has, for example, an input section 111 including a keyboard and the like for inputting characters and the like and an openable and closable display section 112 for displaying an image. In addition, FIG. 11 illustrates the opened display section 112. The fuel cell 120 is attached to the rear face of the device body 110.

In the foregoing embodiment, the description has been given specifically of the structures of the fuel cartridge 10, the fuel cell body 20, and the power generation section 30. However, the fuel cartridge 10, the fuel cell body 20, and the power generation section 30 may have other structure, or may be made of other material. For example, in the foregoing embodiment, the description has been given of the case that the fuel is directly injected into the fuel storage space 12 of the package 11. However, it is possible that an inner pouch made of an aluminum laminated film or the like is provided in the fuel storage space 12, the fuel is contained in the inner pouch, and thereby vacuum state is not generated at the time of suctioning the fuel.

Further, for example, in the foregoing embodiment and the foregoing examples, the description has been given of the case that the power generation section 30 is the flat plate power generation body in which the plurality of unit cells 30A to 30F are layered in the horizontal direction (lamination in-plane direction). However, the embodiment is able to be applied to a case that the power generation section has one unit cell, or a case that the plurality of unit cells are layered in the longitudinal direction (lamination direction) to structure a fuel cell stack.

In addition, for example, the material and the thickness of each element, the method of manufacturing a fuel cell, the method of loading the fuel cartridge 10 onto the fuel cell body 20 and the like are not limited to those described in the foregoing embodiment. Other material, other thickness, other manufacturing method, and other loading method may be adopted.

In addition, for example, the liquid fuel may be other liquid fuel such as ethanol and dimethyl ether other than methanol.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-9. (canceled)

10. A fuel cartridge comprising:
a package containing a fuel for a fuel cell body, wherein the package has a fitting groove for fitting to the fuel cell body.

11. The fuel cartridge according to claim 10, wherein the package has a valve for delivering the fuel, and
the valve does not project from an outer surface of the package.

12. The fuel cartridge according to claim 11, wherein an end of the fitting groove is in the same plane as that of an end of the valve.

13. The fuel cartridge according to claim 11, wherein the package has, in the same plane as that of an end of the valve, a cartridge information storage circuit storing information on the fuel contained in the package, and a communication terminal for communicating the cartridge information storage circuit with the fuel cell body.

14. The fuel cartridge according to claim 10, wherein the package has the shape of a flat rectangular solid, and the fitting groove is provided in a plane including the shortest side of the package.

15. A fuel cell comprising:
a fuel cell body generating power by being supplied with a fuel and oxidant gas; and
a fuel cartridge,
wherein the fuel cartridge includes a package containing the fuel for the fuel cell body, and
the package has a fitting groove for fitting to the fuel cell body.

16. The fuel cell according to claim 15, wherein the package has a valve for delivering the fuel, and
the valve does not project from an outer surface of the package.

17. The fuel cell according to claim 16, wherein the fuel cell body has a valve connection pipe corresponding to the valve and a fitting projection corresponding to the fitting groove, and
a length of the fitting projection is longer than a length of the valve connection pipe.

18. An electronic device including a fuel cell having a fuel cell body generating power by being supplied with a fuel and oxidant gas and a fuel cartridge,
wherein the fuel cartridge includes a package containing the fuel for the fuel cell body, and
the package has a fitting groove for fitting to the fuel cell body.
